(19) United States
(12) Patent Application Publication
(10) Pub. No.: US 2025/0162732 A1
(43) Pub. Date: May 22, 2025

(54) PARTICLE BED FUEL ELEMENT FOR NUCLEAR THERMAL PROPULSION

(71) Applicant: Dark Fission Space Systems Inc., Huntington Beach, CA (US)

(72) Inventors: Gregory George Loboda, Huntington Beach, CA (US); Fred George William Kennedy, III, Huntington Beach, CA (US); Mike Jacox, Huntington Beach, CA (US)

(21) Appl. No.: 18/755,508

(22) Filed: Jun. 26, 2024

Related U.S. Application Data
(60) Provisional application No. 63/524,418, filed on Jun. 30, 2023.

(51) Int. Cl. B64G 1/40; G21C 1/07; G21C 5/08

(52) U.S. Cl. CPC B64G 1/408; G21C 5/08; G21C 1/07

(57) ABSTRACT

One variation of a reactor assembly for a nuclear thermal propulsion system includes a set of fuel elements arranged within a moderator block. Each fuel element, in the set of fuel elements, includes: a cold shell; a compliance structure; a fuel bed; and a hot shell.

### CROSS-REFERENCE TO RELATED APPLICATIONS

This Application claims the benefit of U.S. Provisional Application No. 63/524,418 filed on 30 Jun. 2023, which is incorporated in its entirety by this reference.

### TECHNICAL FIELD

This invention relates generally to the field of nuclear thermal rocket propulsion and more specifically to a new and useful fuel element powering a nuclear thermal rocket propulsion system.

### BRIEF DESCRIPTION OF THE FIGURES

FIG. 1 is a representation of a rocket including one variation of a nuclear thermal propulsion system;

FIG. 2 is a representation of one variation of the fuel element of the nuclear thermal propulsion system;

FIG. 3 is a representation of one variation of a fuel element of the nuclear thermal propulsion system;

FIG. 4 is a representation of one variation of a compliance structure of the fuel element;

FIG. 5 is a representation of nuclear fuel particles within the fuel bed;

FIG. 6 is a representation of nuclear fuel particles in a packed formation; and

FIG. 7 is a representation of a hot cap of the fuel element.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

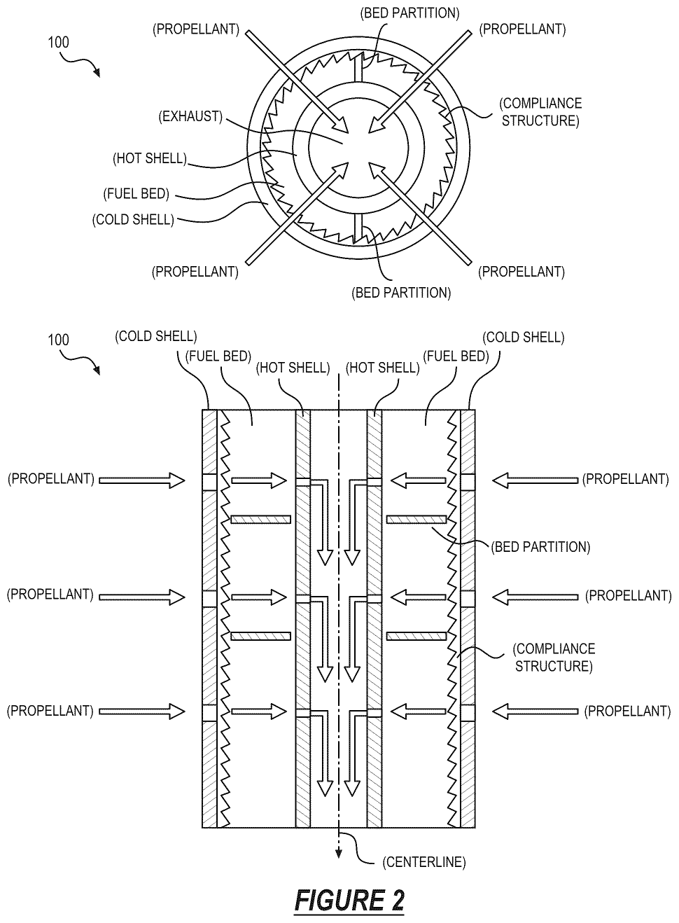

As shown in FIG. 2, a fuel element includes: a cold shell; a compliance structure; a fuel bed; and a hot shell.

The cold shell: defines a cylindrical geometry including an array of cold perforations and an interior cold surface; is arranged within a moderator bore of a moderator block; and is configured to direct propellant radially inwardly from the moderator bore through the array of cold perforations, and toward the fuel bed.

The fuel bed includes a set of nuclear fuel particles and configured to release thermal energy via nuclear fission.

The compliance structure: is interposed between the fuel bed and the cold shell; isolates the interior cold surface from direct contact with the fuel bed over a range of operating temperatures of the fuel bed; is configured to pass propellant from the cold shell toward the fuel bed; and configured to elastically deform radially and longitudinally to absorb thermal movement of the fuel bed over the range of operating temperatures. In one implementation, the compliance structure includes: ribs configured to elastically deform in axial and radial directions responsive to thermal expansion of the fuel bed; and bed partitions extending radially inwardly into the fuel bed to separate the fuel bed into axial and annular fuel bed segments.

The hot shell: defines a cylindrical geometry including an array of hot perforations, an interior chamber, and an outlet port; is coaxial with the cold shell; cooperates with the compliance structure to contain the fuel bed; and is configured to direct propellant, heated by the fuel bed, radially inwardly from the fuel bed into the interior collection volume. The interior collection volume is configured to collect propellant longitudinally out of the fuel element via the outlet port.

### 2. Applications

Generally, a reactor assembly 100 within a nuclear thermal propulsion rocket (or “nuclear rocket engine”) includes a set of cylindrical fuel elements arranged within a moderator block. A fuel element includes a cold shell, compliance structure, fuel bed, and hot shell. The fuel element is configured to: maintain a fuel bed of nuclear fuel particles and direct a flow of propellant through the fuel bed. The propellant: flows through the cold shell; through the fuel bed where the propellant absorbs thermal energy from the fission reaction of the nuclear fuel particles; and then flows through the hot shell to an exhaust outlet. Once heated by the fuel bed, the propellant: exits the fuel element via the exhaust outlet; gathers within a thrust chamber; and accelerates through a nozzle to produce thrust.

A reactor assembly 100 includes a set of fuel elements arranged within a moderator block. The moderator block defines a set of bores, each of which locates a fuel element. The moderator block distributes propellant—such as output by a set of turbopumps—longitudinally to each bore and thus to each fuel element. Each fuel element directs the flow of propellent inwardly such that the propellant flows radially inwardly through gaps between nuclear fuel particles that are closely packed within the fuel element. More specifically, nuclear fuel particles in a fuel element (i.e., a “fuel bed”) undergo nuclear fission, which releases heat absorbed by the propellant flowing directly over the fuel bed. Each fuel element then directs heated propellant longitudinally aftward, out of the fuel element and moderator block, and then into a thrust chamber. The thrust chamber thus collects heated propellant from the array of fuel elements and directs this heated propellant toward a nozzle, which accelerates the heated propellant out of the nuclear rocket engine to produce thrust.

In one implementation, the fuel element of the nuclear thermal propulsion system is configured to heat the propellant (e.g., H₂) from ˜300K to ˜3000K over a radial fuel bed depth between one and five centimeters. More specifically, the fuel element can support an annular fuel bed between one and five centimeters of radial width containing nuclear fuel particles that output sufficient thermal energy during fission to heat propellent—flowing radially inwardly through the annular fuel bed—from a nominal temperature (e.g., ˜300K) to an output temperature of ˜3000K.

The fuel element includes a compliance structure: configured to absorb thermal expansion and contraction of the fuel bed when the nuclear rocket engine is repeatedly activated and deactivated during intermittent operation; configured to isolate a cold shell of the fuel element from hot and expanding nuclear fuel particles; and configured to maintain consistent distribution of nuclear fuel particles within the fuel bed over multiple (e.g., dozens, hundreds) active/inactive operation cycles. In one implementation, the compliance structure includes bed partitions configured to divide the fuel bed into axial segments, such as a stack of multiple annular fuel bed segments isolated by bed partitions that: prevent vertical migration of individual nuclear fuel particles within the fuel bed; and prevent preferential collection (e.g., “ballooning,” “slumping,” or “sagging”) of nuclear fuel particles at the aftward end of the fuel element; and thus prevent uneven or large pressure gradients across the interior surface of the cold shell over multiple active/inactive operation cycles. More specifically, the bed partitions can prevent the nuclear fuel particles from settling into one area or end of the fuel element, which may otherwise cause: uneven heating of the propellant; failure of the cold shell due to uneven hoop stress or pressure from uneven distribution and/or thermal expansion of the nuclear fuel particles; and/or localized melting of the nuclear fuel particles and/or adjacent reactor components due to localized overheating. The compliance structure can additionally include bed partition extrusions (i.e., vertical particles or vanes) configured to direct propellant non-radially through the fuel bed, such as to achieve longer contact durations between the propellant and nuclear fuel particles and thus achieve greater temperatures of the propellant exiting the fuel element.

Generally, the nuclear fuel particles in the fuel bed expand and contract within the compliance structure due to changes in temperature within the fuel element resulting from nuclear fission with the fuel bed. For example, a fuel element without bed partitions exhibits expansion and contraction of the nuclear fuel particles within the fuel element, and acceleration of the nuclear rocket engine along the reactor's longitudinal axis may cause the nuclear fuel particles to move relative to one another and may thus cause these nuclear fuel particles to settle into one end of the compliance structure. Once the nuclear rocket engine is deactivated (and thus cooled) and later reactivated, the displaced nuclear fuel particles may reheat and expand unevenly within the fuel element. In this example, a region of the fuel bed containing a higher density of fuel particles caused by settling may: exhibit a greater rate of fission due to this greater fuel density; thereby exceeding an operating temperature range of the fuel element; exhibit greater and more rapid absolute thermal expansion; and thus apply greater outward force against the compliance layer and the cold shell, which may result in cracking, deformation, and/or failure of the cold shell. Therefore, the fuel element includes the bed partitions to partially or fully isolate annular clusters of nuclear fuel particles within the fuel bed and to maintain each nuclear fuel particle within a target radius of an original position over multiple activation/deactivation (e.g., throttle up and throttle down) cycles and acceleration/deceleration conditions at the nuclear rocket engine.

Therefore, as shown in FIG. 2, the nuclear thermal propulsion rocket system can include a compliance structure and bed partitions configured to separate the fuel bed from the cold shell, to expand with the fuel bed, and to partition the fuel bed into segments over many (e.g., dozens, hundreds) thermal cycles, such as: from a 200K during reactor quiescence to critical reaction conditions exceeding 3000K.

For example, the compliance structure can include a perforated or porous cylindrical structure defining: vertical flexures (or “ribs”) extending longitudinally and configured to absorb radial forces applied to the compliance structure due to radial expansion of the fuel bed; and radial flexures (or “ribs”) extending radially and configured to absorb vertical forces applied to the compliance structure due to longitudinal expansion of the fuel bed under partial- or full-thrust conditions. Each bed partition can include a singular solid disc, such as discrete from or physically coextensive with the compliance structure. Alternatively, each bed partition can include a set of nesting (i.e., non-overlapping) annular discs, a set of overlapping discs, or a set of radially interlocking annular discs that cooperate to form an annular partition and to absorb radial thermal gradients across the fuel bed.

Therefore, throughout multiple thermal cycles (e.g., thrust cycles or “burns” of the nuclear rocket engine) the compliance structure can maintain nuclear fuel particles within consistent segments of the fuel bed and maintain a packing distribution of these fuel particles such that propellant can: flow consistently through the fuel bed; consistently extract heat from the fuel bed to prevent hot spots within the fuel bed; and yield predictable thrust from the nuclear rocket engine.

### 2.1 Low Enriched Uranium Fuel Particles

The fuel element includes a fuel bed of nuclear fuel particles. Each nuclear fuel particle can include low-enriched uranium (LEU), such as at a ratio of two parts uranium-235 to ten parts uranium-238. Each nuclear fuel particle can define an approximately spherical geometry (e.g., 800-1200 microns in outer diameter) and can include: an LEU kernel of a first diameter (e.g., 600-1000 microns); and layers of carbon, refractory, and/or ceramic materials that encase and isolate the LEU core.

To reach criticality of a fission reaction, the fuel bed contains a target ratio for the total mass of Uranium-235 per unit volume. Generally, LEU fuel contains a lower density of U-235 than high-enriched uranium (HEU) fuel. Therefore, to reach the target ratio of U-235 per unit volume for fission criticality with LEU fuel particles rather than HEU particles, each fuel particle in the fuel element defines a larger outer diameter and contains a larger volume of LEU. Accordingly, these large LEU fuel particles form larger interstitial volumes between adjacent nested particles that yield reduced resistance (or “head loss”) to flow of propellant through the nuclear fuel particles, increased propellant mass flow rates through the fuel element, and therefore increased cooling capacity around the nuclear fuel particles.

However, these larger LEU fuel particles may be more prone to movement within the fuel element during repeated thermal cycling, which may result in clumping of the fuel particles near one end of the fuel element and thus uneven cooling of the fuel particles by the propellant, as shown in FIG. 6. Therefore, the fuel element can include the compliance structure and bed partitions that: expand with thermal expansion of the fuel particles; and cooperate to maintain distribution of the fuel particles between the cold and hot shells.

### 3. Geometries

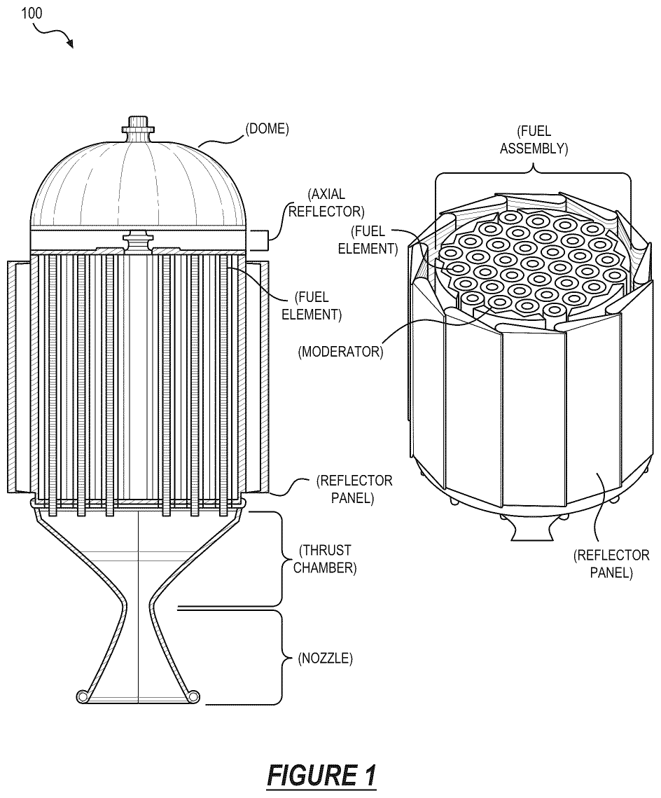

Generally, a reactor assembly 100 within a nuclear thermal propulsion rocket (or “nuclear rocket engine”) includes a set of cylindrical fuel elements (e.g., a centered hexagonal number containing 7, 19, 37, 61, 91, or more fuel elements) arranged within a moderator block. The moderator block includes a set of bores defining a bore for each fuel element in the set of fuel elements. The bores of the moderator are textured (e.g., splined, crenelated, or fluted) to support the fuel element and define a void or multiple voids for propellant to flow between the bore and the fuel element, as shown in FIG. 1.

Each fuel element includes a set of components defining a cylindrical geometry with a common length and different diameters. The cylindrical components are arranged concentrically including: the cold shell, the fuel bed within the compliance structure, and the hot shell. The cold shell defines the outer-most layer of the fuel element, and the hot shell defines the inner-most layer of the fuel element. The fuel bed is arranged between the cold shell and the hot shell.

The cold shell defines: an outer surface abutting a bore of the moderator block and; an inner surface abutting a compliance structure surrounding the fuel bed. The cold shell includes perforations through which propellant flows from the outer surface to the inner surface. The perforations of the cold shell direct propellant into the fuel bed,

The hot shell includes: an outer surface abutting the fuel bed; an inner surface defining a collection chamber configured to collect heated propellant; and an outlet port configured to direct the heated propellant out of the fuel element and into a manifold of the fuel assembly.

The fuel bed includes a set of nuclear fuel particles (e.g., approximately 1 mm spherical particles) tightly packed within an annular volume suspended between the hot shell outer surface and the compliance structure. The compliance structure is a mesh or otherwise highly porous structure configured to retain the nuclear fuel particles between the cold shell and the hot shell. The compliance structure is configured to expand in response to changes in bulk volume produced within the fuel bed when subjected to thermal gradients during operation. For example, the compliance structure can include ribbing and/or folds that allow the compliance structure to expand and contract responsive to thermal expansion and contraction of the hot shell and/or the fuel bed. The compliance structure can include ribbing and/or folds that allow the compliance structure to expand in both the axial and the radial directions.

The compliance structure can additionally include a first set of bed partitions that divide the length of the compliance structure (e.g., the axial/longitudinal length) into segments. In one implementation, the first set of bed partitions are perpendicular to the longitudinal axis of the fuel element and form annular segments of the cylindrical fuel bed. For example, for a fuel element that is 40 cm in length, the compliance structure can include a first set of 9 bed partitions, each approximately 4 cm apart, to divide the length of the fuel bed into 10 annular segments of approximately 4 cm in height. The bed partitions prevent the nuclear fuel particles from sinking or compacting to one end of the fuel element that could cause uneven heating throughout the fuel element, thereby leading to excessive thermal stresses on the fuel element and overheating of the fuel particles.

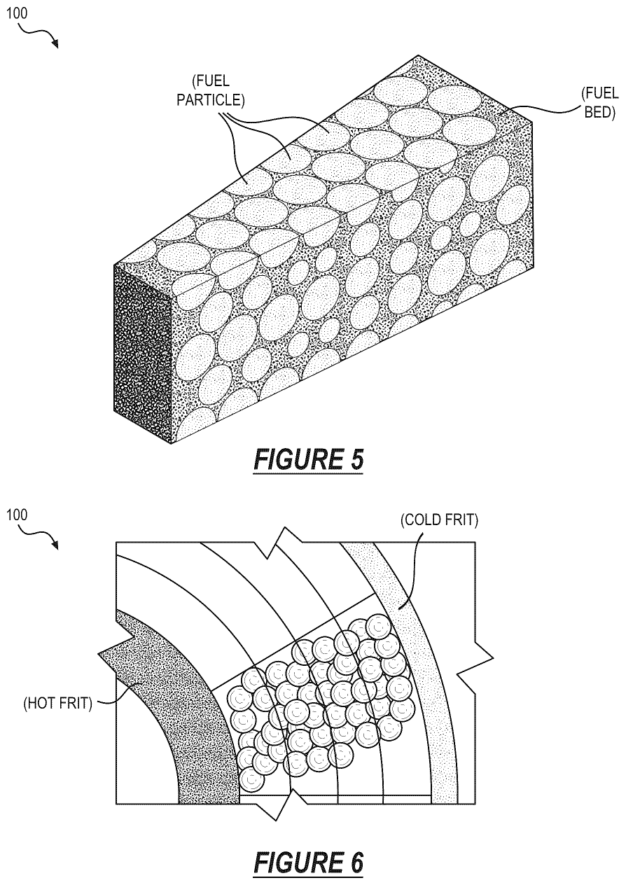

The compliance structure can additionally include a second set of bed partitions that divide the annular segments into multiple arcs-shown in FIGS. 5 and 6. The second set of bed partitions are arranged parallel to and offset from the longitudinal axis of the fuel element. In one example, the second set of bed partitions are positioned to divide each annular segment of the fuel bed into six 60° arcs. The second set of bed partitions prevent the nuclear fuel particles from shifting to one lateral end of the fuel element resulting in uneven heating, stress to the cold shell and hot shell, and loss of thrust.

The bed partitions can additionally direct the flow of propellant through the fuel bed to maximize propellant contact with the nuclear fuel particles and thereby increase the heating of the propellant.

3.1 Example: Fuel Element with Radial Propellant Flow

In one example, a fuel element is configured to restrict the flow of propellant to the radial direction. In this example, the fuel element is characterized by: a 20 cm length; an outer radius (e.g., of the cold shell) of 5 cm; an inner radius of 0.75 cm; and 9 bed partitions dividing the fuel bed into 10 annular segments, each with an approximate height of 2 cm. The bed partitions direct the flow of the propellant across the fuel bed in the radial direction. In this example, the propellant flows 4 cm through the fuel bed and absorbs thermal energy. At a first position of the cold shell, the propellant enters the fuel bed at a temperature of 400K. At the hot shell, the propellant exits the fuel bed to the collection chamber at a temperature of 3000K. The fuel bed produces thermal energy that is absorbed by the propellant as the propellant flows across each nuclear fuel particle of the 4 cm radial path directed by the bed partitions.

3.2 Example: Fuel Element with Axial and Radial Propellant Flow

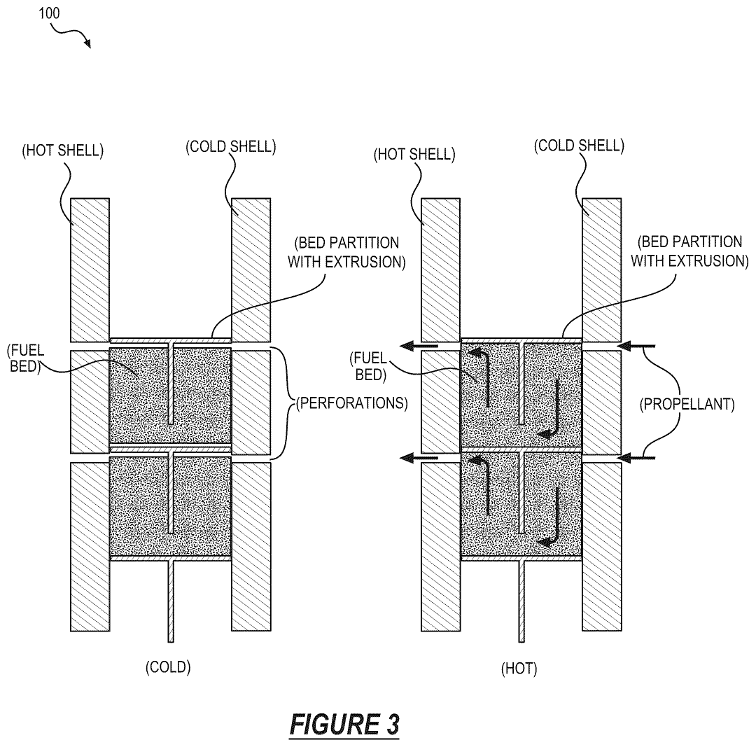

In another example, a fuel element is configured to restrict the flow of propellant to a path in both the axial and the radial direction. In this example, the fuel element is characterized by: a 40 cm length; an outer radius (e.g., of the cold shell) of 3 cm; an inner radius (e.g., of the hot shell) of 0.5 cm; and 9 bed partitions dividing the fuel bed into 10 annular segments, each with an approximate height of 4 cm. Each bed partition additionally includes an extrusion extending perpendicularly from the bed partition-shown in FIG. 3. The bed partition extrusion blocks the propellant from flowing across the fuel bed in a radial direction. In this example, the propellant flows into the fuel bed in the radial direction, encounters the bed partition extrusion, flows in the axial direction (e.g., down the extrusion), and flows out of the fuel bed in the radial direction. While the fuel element in this example includes a fuel bed width of 2 cm, the bed partition and the bed partition extrusion direct the propellant to flow 4 cm through each segment of the fuel bed. The heating of the propellant is directly proportional to the amount of time the propellant is in contact with the nuclear fuel particles, and thereby proportional to the length of the path of the propellant. Therefore, in this example, the propellant is heated from 400K to 3000K within the fuel element that is longer and narrower than the fuel element of the previous example.

Therefore, bed partitions (e.g., both axially and longitudinally arranged) and bed partition extrusions can alter the path of the propellant through the fuel bed and therefore the amount of thermal energy absorbed by the propellant.

### 4. Fuel Element Components

Each fuel element within a reactor assembly 100 of a nuclear thermal propulsion system includes: a cold shell; a compliance structure; a fuel bed contained within the compliance structure; and a hot shell. The fuel element: receives propellant (e.g., H2) from a bore within the moderator supporting the fuel element; and directs the propellant through a fuel bed of the fuel element to increase the temperature of the propellant; and directs the propellant to a combustion chamber (e.g., a thrust chamber downstream of the fuel element) of the nuclear rocket engine.

### 4.1 Cold Shell

The cold shell: defines a cylindrical geometry including an array of cold perforations and an interior cold surface; is arranged within a moderator bore of a moderator block; and is configured to direct propellant radially inwardly from the moderator bore through the array of cold perforations, and toward the fuel bed. The cold shell can define the outermost layer of the fuel element. The cold shell forms a cylindrical shell (e.g., a hollow cylinder) around the fuel bed. The cold shell can define a length of 10-50 cm; an outer diameter of 1-10 cm; and a thickness of 0.05-1 cm, as shown in FIG. 3.

### 4.1.1 Cold Perforations

The cold shell includes an array of perforations configured to: separate the fuel bed from the moderator; to receive propellant pumped into moderator bores in the moderator via a set of upstream pumps; and to distribute this propellant across the fuel bed.

In one implementation, the cold shell is a thin-walled cylindrical structure including a uniform distribution of perforations across an external surface of the structure.

In another implementation, the cold shell is a thin-walled cylindrical structure including a non-uniform pattern of perforations across the external surface of the structure. The non-uniform pattern of perforations: enable a pressure boundary along the surface of the cold shell to meter flow throughout the fuel bed; and enable greater mass flow in the center of a fuel bed segment where power density can be highest. For example, as described in the example of the fuel element with radial propellant flow, the compliance structure can include bed partitions that divide the compliance structure into a set of annular segments, each annular segment containing a subset of the nuclear fuel particles of the fuel bed. In this example, the pattern of perforations is arranged on the external surface of the cold shell to align a subset of the perforations with each annular segment of the compliant structure. The pattern of perforations can further include portions of the cold shell that align with bed partitions lacking perforations. Therefore, the pattern of perforations enables flow of propellant to each annular segment of the fuel bed between the bed partitions and prevents flow colliding with a bed partition (e.g., where the propellant cannot flow through the fuel bed).

In this implementation, the cold shell can include: a first array of perforations (e.g., slits, holes) of a first (average) size (e.g., 0.1 mm diameter) and centered within an annular segment of the fuel bed between bed partitions; and a second array of perforations of a second (average) size (e.g., 0.5 mm diameter) greater than the first size and arranged proximal the bed partitions.

In a similar implementation, the cold shell can include an array (or “gradient”) of perforations characterized by smaller perforation sizes (e.g., 0.1 mm diameter) proximal the bed partitions and larger perforation sizes (e.g., 0.5 mm diameter) proximal the center of an annular segment of the fuel bed (e.g., distal a bed partition).

Accordingly, in the foregoing implementations, the cold shell can preferentially direct propellant into the fuel bed proximal the bed partitions, thereby enabling the propellant to cool the bed partitions. The cold shell directs the flow of propellant: through the fuel bed to collect thermal energy from the fuel particles. The propellant exits the fuel element via the perforations of the hot shell. For example, the cold shell can preferentially pass: a high mass flow of propellant into the fuel bed proximal the bed partitions; and a low mass flow of propellant into the fuel bed centered between the bed partitions. Larger perforations in the cold shell proximal (e.g., adjacent) the bed partitions may therefore cause reduced cooling of the bed partitions by the propellant due to boundary layer conditions.

### 4.1.2 Cold Shell Material

In one implementation in which the moderator block exhibits a melting temperature below the operating temperature of the fuel assembly, the cold shell includes a porous ceramic or ceramic alloy exhibiting low thermal conductivity such that the cold shell can: conduct limited thermal energy from the fuel bed into the moderator; and thus function as an insulator between the hot fuel bed and the low-temperature moderator.

In another implementation in which the nuclear rocket engine includes a high propellant mass flow and in which the propellant cools the moderator and the cold shell, the cold shell includes a porous aluminum or an aluminum alloy (e.g., 1100 Al) exhibiting high ductility and high thermal conductivity such that the cold shell can: expand and contract with thermal cycles without plastic deformation; conduct thermal energy evenly across the wall thickness of the cold shell; and thus exhibit a low thermal gradient—and therefore near-uniform stress and strain—across the wall thickness of the cold shell during operation of the nuclear rocket engine.

### 4.1.3 2 Cold Shell Manufacturing

In one implementation, the cold shell is manufactured by: extruding or drawing a thin-walled cylinder; and laser-cutting, etching, or ablating (e.g., via wire-EDM) the thin-walled cylinder to form the array of perforations.

In another implementation, powdered material and a binder is molded into a cylinder and then partially sintered to form the cold shell exhibiting a material density less than a nominal density of the material. Accordingly, the cold shell can exhibit a target porosity that directs propellant to flow through the cold shell.

In one implementation, the moderator bore includes a radial array of splines (or “flutes”): extending radially inwardly toward an axial center of the moderator bore; and configured to radially locate the cold shell within the moderator bore. For example, the radial array of splines can extend inwardly to intersect an inner are of diameter slightly less than an outer diameter of the cold shell at a nominal operating temperature or a static cold temperature (e.g., 300K). Accordingly, the radial array of splines can retain the cold shell within the moderator bore via an interference fit. In another example, the radial array of splines can include three linear, involute splines extending parallel to the axis of the moderator bore and offset at 120° intervals about the moderator bore. In this example, these three splines can thus define three propellant bores configured to: distribute propellant vertically and radially about a large proportion of (e.g., 90% of) the total external surface area of the cold shell. However, the radial array of splines can include any other quantity and geometry of splines and can cooperate in any other way to locate the cold shell within the moderator bore and to form propellant bores that distribute propellant to the external surface of the cold shell.

In this implementation, the cold shell can also include a set of flanges configured to align with the array of splines in the moderator bore. The set of flanges are arranged to nest between the array of splines of the moderator bore, thereby maintaining a position of the cold shell within the moderator bore. The set of flanges can extend in a direction normal to the external surface of the cold shell. For example, each flange can define a rectangular prism geometry including: a length equal to the length of the cold shell; a width configured to fit between the moderator bore splines; and a height configured to abut a distal edge of the flange against the moderator bore.

In one implementation the cold shell can nest within a moderator bore of a solid moderator block exhibiting a melting temperature of 350K. The interior surface of the cold shell can exhibit a temperature of up to 400K. Therefore, the set of flanges can include a ceramic material exhibiting a low thermal conductivity material, thereby insulating the solid moderator block from the temperature of the cold shell to prevent melting of the moderator bore.

### 4.2 Fuel Bed

The fuel bed includes a set of approximately spherical nuclear fuel particles. The nuclear fuel particles are arranged between the compliance structure and the hot shell. In one example, the nuclear fuel particles are close-packed—such as in a body-centered cubic packing arrangement with a nominal packing density between 60 and 65%—between the compliance structure and the hot shell to form the fuel bed. In this example, the fuel bed can also fill: 100% of the volume between the compliance structure and the hot shell at the nominal packing density; and less than 100% (e.g., 90-95%) of the volume between the cold shell and the hot shell. Accordingly, the compliance structure can expand radially toward the cold shell to accommodate thermal expansion of the fuel bed during operation, as shown in FIG. 5.

In one example, each fuel particle: defines a spherical particle between 0.5 and 2 mm in diameter; and includes a uranium carbide or uranium nitride core with a porous graphite coating, a high-density graphite, and a zirconium carbide, tungsten carbide, or tungsten outer shell.

### 4.2 Compliance Structure

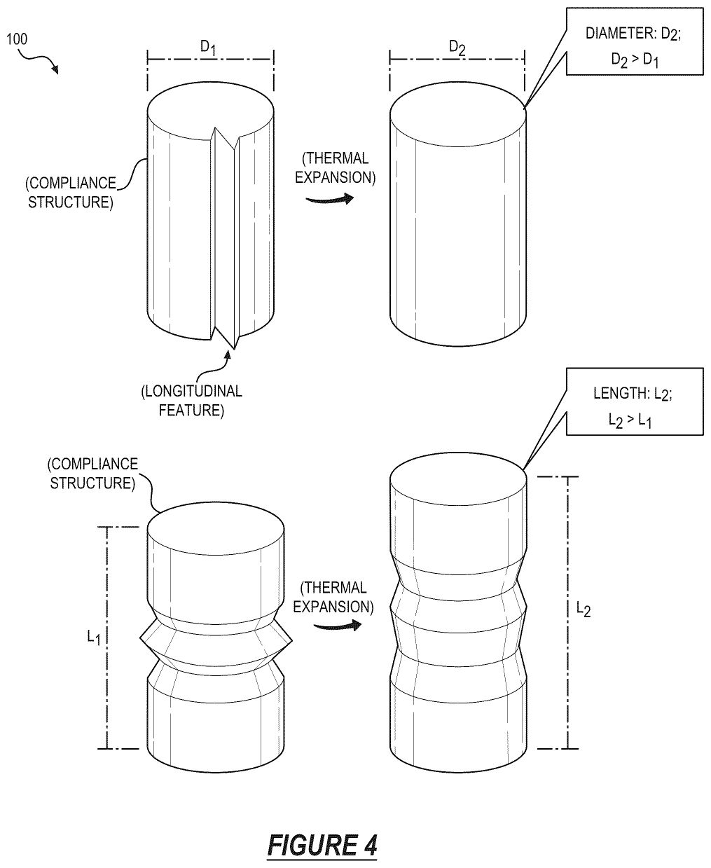

The fuel bed of the fuel element includes a compliance structure configured to contain the nuclear fuel particles of the fuel bed. The compliance structure includes a mesh or otherwise perforated material that encapsulates the set of nuclear fuel particles and maintains the nuclear fuel particles between the cold shell and the hot shell such that propellant can flow between the nuclear fuel particles for heating. The compliance structure is characterized by a malleable material that expands and contracts with the thermal expansion of the hot shell, the fuel particles, and the cold shell. The compliance structure maintains the fuel bed throughout hundreds of extreme (e.g., 200K to 3000K) thermal cycles without exhibiting permanent deformation. The compliance structure: accommodates mechanical expansion of the fuel bed and hot shell due to these thermal cycles; and maintains the fuel bed within a target form (e.g., a target thickness, density), as shown in FIG. 4.

### 4.2.1 Compliance Structure Geometry

The compliance structure defines a cylindrical shell arranged between the cold shell and the fuel bed. The nominal dimensions of the compliance structure include: a diameter 1-5% less than the diameter of the cold shell; and a length within 5% of the cold shell and the hot shell lengths.

### 4.2.2 Compliance Structure Material

In one variation in which the cold shell includes a diameter of 10 cm, the compliance structure is characterized by a polytetrafluoroethylene (PTFE) mesh. The PTFE mesh is configured to withstand deformation (e.g., elastic expansion and contraction) caused by thermal expansion of the nuclear fuel particles within the compliance structure. The PTFE mesh is configured to accommodate the thermal expansion of a wide fuel element (e.g., the example fuel element with radial propellant flow, and/or including a 10 cm diameter cold shell).

In one variation in which the cold shell includes a 5 cm diameter, the compliance structure includes a stainless-steel material (e.g., 440 stainless steel). The stainless-steel material can define a malleable mesh or a low-density shell. The stainless-steel material exhibits a high mechanical strength to ensure the nuclear fuel particles are maintained within the fuel bed by the compliance structure during thermal cycles.

### 4.3.3 Compliance/Elastic Deformation

In one implementation, the compliance structure is configured to expand by deforming a series of features of the surface of the compliance structure—shown in FIG. 4. The features can include ribs, folds, crenelations, zig zags, or other manipulations of the material of the compliance structure. The features increase the surface area of the compliance structure such that the compliance structure can expand due to: mechanical forces such as pressure from the hot shell and fuel bed expanding into the compliance structure; and/or thermal expansion.

In one example, the compliance structure includes longitudinal features (e.g., features parallel to the longitudinal axis of the fuel element) such that the compliance structure can expand radially. In this example, the diameter of the compliance structure including longitudinal features can increase up to 5%

In one example, the compliance structure includes lateral features (e.g., parallel to the lateral axis) of the fuel element such that the compliance structure can expand longitudinally. In this example, a compliance structure including lateral features can increase in length by up to 5%.

In another example, the compliance structure can include both lateral and longitudinal features such that the compliance structure can expand in both longitudinal and radial directions. The features of the compliance structure can overlap and/or intersect to enable the compliance structure to expand in multiple axes.

The compliance structure can additionally include features non-parallel to the lateral or longitudinal axis such as diagonal ribs. The compliance structure can also include non-linear features, such as ripples and waves, that increase the surface area of the compliance structure to enable the compliance structure to expand.

### 4.4 Bed Partitions

The fuel element can include bed partitions arranged within the compliance structure. The bed partitions are configured to: divide the compliance structure into segments; and maintain a subset of nuclear fuel particles within a segment of the compliance structure.

### 4.4.1 Longitudinal Bed Partition Geometry

In one implementation, the fuel element can include longitudinal bed partitions (e.g., parallel to and offset from the longitudinal axis of the fuel element) that divide the annular compliance structure into arcs. The longitudinal bed partitions maintain a subset of nuclear fuel particles within an are of the annular compliance structure such that the subset of nuclear fuel particles does not shift laterally or settle to one side of the fuel element. In one implementation, the compliance structure includes rib features; and the longitudinal bed partitions are arranged between the rib features for support. In one variation, the longitudinal bed partitions are permanently or removably attached to the compliance structure for support. In this variation, the longitudinal bed partitions can include extendable elements such that the longitudinal bed partitions expand in response to thermal expansion of the compliance structure and/or other components of the fuel element (e.g., the cold shell or the hot shell). The extendable elements of the longitudinal bed partitions can include a slat configured to slide past another slat to overlap the slats.

### 4.4.2 Lateral Bed Partition Geometry

In another implementation, the fuel element can additionally include lateral bed partitions (e.g., parallel to the lateral axis of the fuel element) to divide the annular compliance structure into multiple annular segments. For example, a 20 cm fuel element can include nine equally-spaced lateral bed partitions to divide the compliance structure into 10 annular segments, wherein each annular segment includes a height of 2 cm. The lateral bed partitions maintain a subset of nuclear fuel particles within an annular segment of the compliance structure such that the nuclear fuel particles cannot settle to one end of the fuel element.

In one implementation, the compliance structure includes lateral rib features, and the lateral bed partitions are arranged between the lateral rib features for support. In this variation, the lateral bed partitions can include extendable elements such that the lateral bed partition can expand and contract with the compliance structure. For example, a lateral bed partition can include multiple stacked slats configured to slide past each other to expand and contract with the compliance structure. In one implementation, the lateral bed partitions couple to the cold shell for support. The cold shell exhibits less longitudinal expansion than the hot shell due to lower temperatures proximal the cold shell than the hot shell. Therefore, the cold shell supports the lateral bed partition in an approximately stationary arrangement throughout thermal cycles of the fuel element.

The fuel element can include both lateral and longitudinal bed partitions. For example, for a 20 cm long fuel element, the compliance structure can include: four lateral bed partitions dividing the compliance structure into five two-centimeter-long annular segments; and six longitudinal bed partitions dividing each annular segment into six 60° arcs. In this example, the lateral and longitudinal bed partitions divide the compliance structure into 30 distinct segments (e.g., five annular segments each divided into six arcs) such that the nuclear fuel particles within the compliance structure are divided into 30 subsets of nuclear fuel particles. The lateral and longitudinal bed partitions separate subsets of nuclear fuel particles to: enable an approximately consistent density (e.g., within 5% of an initial density measured at manufacturing) of nuclear fuel particles throughout the compliance structure; and prevent settling of the nuclear fuel particles to one portion (e.g., clumping along the lateral or longitudinal axis) of the compliance structure. The bed partition maintains the subsets of nuclear fuel particles in each segment as the fuel element experiences tilting and acceleration that can shift the nuclear fuel particles to a portion of the compliance structure.

In one variation, bed partitions can include extrusions to direct the flow of propellant in a target path—shown in FIG. 2.

### 4.4.2 Bed Partition Material+Manufacturing

In one implementation the bed partitions can include solid sheets (e.g., non-perforated, non-mesh sheets) of the same material as the compliance structure (e.g., PTFE or 440SS). In this implementation, the bed partitions can be extruded as sheets and cut into flat annuli (e.g., via laser-cutting, etching or ablation). In one variation, the bed partitions can include a perforation pattern configured to direct propellant to flow through adjacent segments of the compliance structure.

In one implementation, during manufacturing, a compliance structure installs between the cold and hot shell. In this variation the compliance structure can include an opening (e.g., a closeable flap or lid) through which a manufacturer can add nuclear fuel particles to the compliance structure. The manufacturer adds subsets of nuclear fuel particles to the compliance structure and places a lateral bed partition on top of the subset of nuclear fuel particles. The manufacturer repeats this step until each lateral bed partition is positioned within the compliance structure and all of the nuclear fuel particles are added.

### 4.5 Hot Shell

The hot shell: defines a cylindrical geometry including an array of hot perforations, an interior chamber, and an outlet port; is coaxial with the cold shell; cooperates with the compliance structure to contain the fuel bed; and is configured to direct propellant, heated by the fuel bed, radially inwardly from the fuel bed into the interior collection volume. The interior collection volume is configured to direct propellant longitudinally out of fuel element via the outlet port.

The hot shell can define an innermost structure (or “layer”) of the fuel element.

### 4.5.1 Hot Shell Geometry+Hot Perforations

The hot shell includes hot perforations allowing propellant to flow from the fuel bed into the collection chamber.

The hot shell includes an array of perforations to: separate the fuel bed from the collection chamber; and to receive heated propellant from the fuel bed. The hot shell can include different diameters of perforations and/or include slits of different lengths or arranged in different directions. In one implementation, the hot shell includes a uniform array of perforations. Because the hot shell is exposed to higher temperatures than the cold shell, the hot shell exhibits a greater change in dimension due to thermal expansion than the cold shell. The hot shell can therefore expand and move relative to the compliance structure such that a segment of the compliance structure: aligns with a first portion of the hot shell at a first temperature (e.g., 400K); and aligns with a second portion of the hot shell at a second temperature (e.g., 2750K). In this implementation, the bed partitions of the compliance structure are not coupled to the hot shell, and the array of perforations of the hot shell are not based on the arrangement of bed partitions within the compliance structure.

### 4.5.2 Hot Shell Material

The hot shell is configured to include a melting temperature at least 2% above the maximum operating temperature of the hot shell (e.g., 2% above 3000K). The hot shell is configured to exhibit a thermal expansion of up to 5% in the longitudinal and radial directions at a temperature gradient of 200-3000K.

The hot shell material selection may include zirconium carbide, rhenium, graphite, or other high-temperature materials. In one variation the hot shell is formed via depositing zirconium carbide into a carbon foam structure to reach 100% density. The carbon foam structure is then removed to create a zirconium carbide structure exhibiting a target porosity (e.g., 10-50% total density).

### 4.5.2 Hot Shell Manufacturing

In one variation, the hot shell includes multiple stacked segments. The segments of the hot shell can include dimples (e.g., hemispherical indentations) and nodes (e.g., hemispherical extrusions) such that the node of one segment can nest within the dimple of another segment to maintain a relative position of the segments. The hot shell can abut springs on each end of the fuel element that apply a preload force to: maintain the stack of segments; and allow the hot shell to expand longitudinally during thermal expansion.

A monolithic (e.g., non-segmented) hot shell or a segmented hot shell can be manufactured via sintering of a ceramic material to a target porosity. In one variation, the array of perforations is formed during sintering. In another variation, the array of perforations is cut into a sintered ceramic cylinder via laser-cutting, etching, or ablation.

### 5. Cold Cap

The fuel assembly can include a cold cap arranged at a first longitudinal end of the fuel element that connects and seals the top ends of the hot and cold shells. The cold cap can include a spring and/or compliance later configured to receive the first ends of the cold and hot shells. The spring and/or compliance: deforms as the cold and hot shells expand due to thermal expansion; and maintains the hot and cold shell within the moderator bore. The cold cap can include: a nuclear poison such as boron and/or cadmium to prevent fission from occurring outside of the fuel element; or a neutron reflector to contain neutrons within the fuel assembly.

### 6. Hot Cap

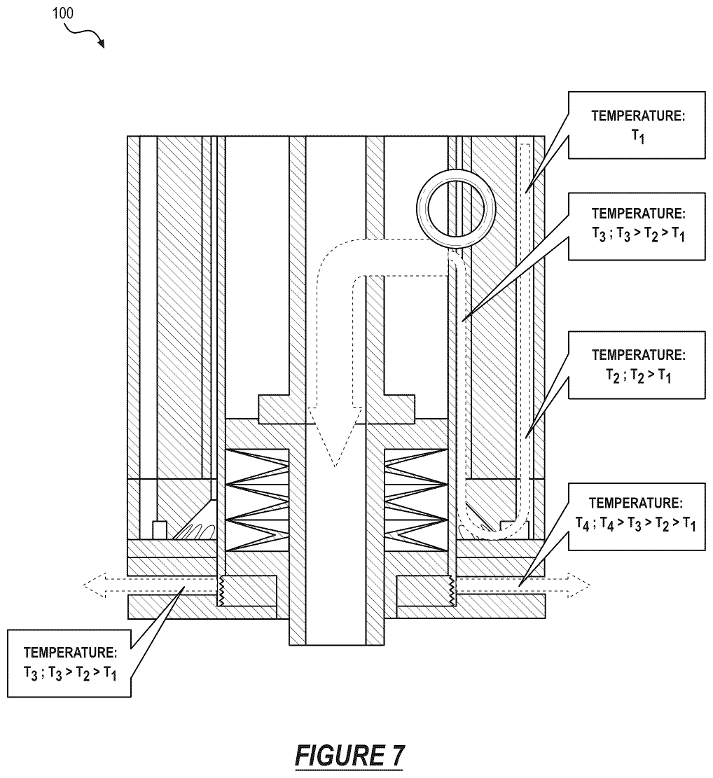

The fuel assembly can include a hot cap arranged at a second longitudinal end of the fuel element that: connects and seals the bottom ends of the hot and cold shells; and defines an outlet for hot propellant to exit the fuel element and enter the combustion chamber. The hot cap can additionally include a spring and/or compliance to maintain the cold and hot shells within the moderator bore—shown in FIG. 7. The hot cap can include: a nuclear poison such as boron and/or cadmium to prevent fission from occurring outside of the fuel element; or a neutron reflector to maintain neutrons within the fuel assembly. The hot cap additionally includes an outlet through which heated propellant exits the fuel assembly and flows into the combustion chamber.

### 7. Perforation Patterns

The cold shell and the hot shell include perforations that cooperate to direct propellant from the moderator bore, through the fuel bed, and into the collection chamber defined by the interior surface of the hot shell. The perforations are configured to maintain a target pressure, mass flow, and/or path of propellant through the fuel bed, as shown in FIG. 7.

In one variation, the perforations of the cold shell can align with the perforations of the hot shell to enable propellant to flow in the shortest possible path through the fuel bed. In another variation the perforations of the cold shell and the hot shell are offset to direct the propellant in a longer flow path through the fuel bed, thereby causing the propellant to absorb more thermal energy and reach a higher temperature than with aligned perforations.

In one implementation, the perforations of the cold shell are arranged in a pattern to direct propellant flow through a segment of the compliance structure. For example, the perforations of the cold shell are arranged to direct the propellant into a segment of the fuel bed by centering the perforation(s) of the cold shell between the bed partitions forming the segment. In another example, the perforations are arranged to evenly disperse the propellant throughout the segment, such as by arranging a pattern of multiple perforations at even intervals of the portion of the cold shell abutting the fuel bed segment.

In one implementation, the hot shell includes perforations patterned independently of the bed partitions. Because the hot shell is exposed to a (much) larger temperature range than the cold shell between operational and non-operating periods (e.g., 300-3000K versus 300-400K, respectively), the hot shell exhibits greater thermal movement between operating and non-operating periods than the cold shell. Accordingly, the hot shell may expand and contract—both radially and longitudinally—by greater distances than the cold shell between operating and non-operating periods. The hot shell may therefore move relative to segments of the fuel bed defined by the bed partitions. Therefore, the hot shell can include an array of perforations: at a uniform density across its interior surface; and therefore independent of locations of segments of the fuel bed.

### 8. Operation Cycle

The nuclear thermal propulsion system including the fuel elements is configured to undergo many (e.g., dozens, hundreds) cycles to supply intermittent, controlled thrust without combustion.

For example, when the nuclear rocket engine enters the vacuum of space and the nuclear thermal propulsion system is not yet activated (e.g., if the nuclear rocket engine includes an initial chemical fuel system for exit from the atmosphere), the fission reactions of the fuel elements are in a sub-critical state, and the temperature of the components of each fuel element are approximately 200K. At this temperature, below the manufacturing temperature, the nuclear fuel particles, cold shell, compliance structure, and hot shell, can contract from the nominal dimension.

When the nuclear thermal propulsion system is activated, the propellant is pumped through the fuel element to cool the nuclear fuel particles. At activation, portions of the fuel element (e.g., the hot shell and the nuclear fuel particles proximal the hot shell) exhibit a temperature of 400K. The portions of the fuel element at 400K can begin to exhibit thermal expansion.

At criticality: a pump directs propellant into the moderator bore toward the fuel element; the cold shell receives the propellant through the perforations, and directs the propellant radially toward the center of the fuel element; the propellant flows through the compliance structure and through interstitials between fuel particles in the fuel bed; the propellant absorbs thermal energy from the fuel bed, thereby increasing temperature from 400K to 3000K over a short distance (e.g., 10 mm); the hot shell collects the heated propellant through the perforations in the collection chamber; the hot shell directs the propellant longitudinally through the collection chamber and to an outlet connected to a thrust chamber of the nuclear rocket engine.

As a person skilled in the art will recognize from the previous detailed description and from the figures and claims, modifications and changes can be made to the embodiments of the invention without departing from the scope of this invention as defined in the following claims.

I claim:

1. A reactor assembly for a nuclear thermal propulsion system comprising:
a set of fuel elements, each fuel element in the set of fuel elements comprising:
a cold shell:
defining a cylindrical geometry including an array of cold perforations and an interior cold surface;
arranged within a moderator bore of a moderator block; and
configured to direct propellant radially inwardly from the moderator bore through the array of cold perforations, and toward a fuel bed;
the fuel bed includes a set of nuclear fuel particles configured to release thermal energy via nuclear fission;
a compliance structure:
interposed between the fuel bed and the cold shell;
configured to isolate the interior cold surface from direct contact with the fuel bed over a range of operating temperatures of the fuel bed;
configured to pass propellant from the cold shell toward the fuel bed; and
configured to elastically deform radially and longitudinally to absorb thermal movement of the fuel bed over the range of operating temperatures; and
a hot shell:
defines a cylindrical geometry including an array of hot perforations, an interior chamber, and an outlet port;
arranged coaxial with the cold shell;
cooperates with the compliance structure to contain the fuel bed; and
configured to direct propellant, heated by the fuel bed, radially inwardly from the fuel bed into an interior collection volume and out of the fuel element via an outlet port.

2. The reactor assembly of claim 1, wherein the compliance structure comprises:
a set of ribs configured to elastically deform in axial and radial directions responsive to thermal expansion of the fuel bed; and
a set of bed partitions extending radially inwardly into the fuel bed to separate the fuel bed into axial and annular fuel bed segments.
